(19) United States
(12) Patent Application Publication
(10) Pub. No.: US 2021/0005962 A1
(43) Pub. Date: Jan. 7, 2021

(54) Antenna substrate and manufacturing method thereof

(71) Applicant: AAC Technologies Pte. Ltd., Singapore City (SG)

(72) Inventors: Hongjuan Han, Shenzhen (CN); Yuehua Yue, Shenzhen (CN)

(21) Appl. No.: 16/990,984

(22) Filed: Aug. 11, 2020

Related U.S. Application Data
(63) Continuation of application No. PCT/CN2019/094410, filed on Jul. 2, 2019.

(51) Int. Cl. H01Q 1/38; H01Q 9/16; H01Q 1/50

(52) U.S. Cl. CPC H01Q 1/38; H01Q 1/50; H01Q 9/16

(57) ABSTRACT

The invention provides an antenna substrate including a feeding board and a calibration board, wherein the feeding board comprises a feeding network for feeding antenna elements; the calibration board comprises a calibration network. Through independent and separate manufacturing of the feeding board and the calibration board, the antenna substrate provided by the invention has the advantages that a back drilling process is not required in the manufacturing process of the antenna substrate, processing is simple and the cost is low. Moreover, the feeding board and the calibration board are independently manufactured separately, so that the calibration board and the feeding board can be manufactured into different sizes, specifically, the size of the calibration board can be reduced, thereby reducing the material cost and reducing the space occupation.

### FIELD OF THE PRESENT DISCLOSURE

The invention relates to the field of antennas, in particular to a base station antenna.

### DESCRIPTION OF RELATED ART

As shown in FIG. 4, a feeding board and a calibration board in an existing large-scale antenna scheme are usually directly manufactured into a whole PCB board in a multi-layer laminating manner. The whole PCB board comprises sequentially stacked power division network layer 501, first dielectric layer 502, first grounding layer 503, bonding layer 504, calibration network layer 505, second dielectric layer 506 and second grounding layer 507, wherein the power division network layer 501 and the first grounding layer 503 form a power division network in a form of a microstrip line; the calibration network layer 505 and the first grounding layer 503 form a calibration network in a form of a strip line; and the power division network and the power division network share the first grounding layer 503. In manufacturing, firstly, a through hole 508 is formed in the whole PCB board and penetrates through the power division network layer 501, the first dielectric layer 502, the first grounding layer 503, the bonding layer 504, the calibration network layer 505, the second dielectric layer 506 and the second grounding layer 507, the purpose of forming the through hole 508 is to form a dense grounding structure on the periphery of the strip line, and then the through hole 508 in the power division network layer 501 and the first dielectric layer 502 is removed through a back drilling process, and the purpose of back drilling is to eliminate conduction of the power division network layer 501 and the first grounding layer 503 caused by forming of the through hole 508, so as to affect the performance of the power division network.

At present, the back drilling process is required for manufacturing the feeding board and the calibration board. However, the back drilling process is complicated in processing and high in cost.

### SUMMARY OF THE INVENTION

One of the main objects of the present invention is to provide an antenna substrate with reduced manufacturing cost.

Another object of the present invention is to provide a manufacturing method of the antenna substrate.

Accordingly, the present invention provides an antenna substrate, comprising: a feeding board comprising a feeding network for feeding a plurality of antenna elements; and a calibration board comprising a calibration network for calibrating an amplitude and a phase of a signal transmitted to the feeding network; wherein the calibration network is electrically connected with the feeding network; and the calibration board and the feeding board are independently manufactured separately and fixed through assembly.

In addition, the antenna substrate further comprises a reinforcement board arranged between the feeding board and the calibration board, wherein the feeding board, the reinforcement board and the calibration board are fixed in a riveting manner.

In addition, the calibration board comprises a first circuit board, a second circuit board arranged at one side of the first circuit board far away from the reinforcement board, and a bonding layer arranged between the first circuit board and the second circuit board; the first circuit board and the second circuit board are bonded and fixed through the bonding layer.

In addition, the first circuit board comprises a first medium board, a first grounding layer and a signal line layer arranged on two opposite surfaces of the first medium board; the second circuit board comprises a second medium board and a second grounding layer arranged on a surface of the second medium board far away from the first circuit board; and the first grounding layer, the first medium board, the signal line layer, the bonding layer, the second medium board and the second grounding layer are sequentially stacked in a direction far away from the reinforcement board from one side of the reinforcement board far away from the feeding board.

In addition, a metallized through hole penetrating through the first medium board, the bonding layer and the second medium board is formed in the calibration board; and the first grounding layer communicates with the second grounding layer through the metallized through hole.

In addition, the antenna substrate further comprises a conductive column, wherein a clearance area is formed in the second grounding layer; a signal transfer board is arranged in the clearance area; an avoidance hole is formed in the feeding board, the reinforcement board, the first circuit board, the bonding layer and the second circuit board in a penetrating manner; the conductive column is arranged in the avoidance hole in a penetrating manner for electrically connecting the feeding network and the signal transfer board; and the signal line layer is electrically connected with the signal transfer board through a metal probe.

In addition, the feeding board comprises a third medium board, and the feeding network and a third grounding layer arranged on two opposite surfaces of the third medium board.

The present invention further provides a manufacturing method of an antenna substrate, comprising the following steps of

S1: providing a feeding board, wherein the feeding board comprises a third medium board, a feeding network and a third grounding layer arranged on two opposite surfaces of the third medium board;

providing a reinforcement board;

providing a calibration board comprising laminated first circuit board, bonding layer and second circuit board, wherein the first circuit board comprises the first medium board, and the first grounding layer and the signal line layer arranged on two opposite surfaces of the first medium board; the second circuit board comprises the second medium board and the second grounding layer arranged on a surface of the second medium board far away from the first circuit board; the first grounding layer, the first medium board, the signal line layer, the bonding layer, the second medium board and the second grounding layer are sequentially stacked; and the metallized through hole communicating with the first grounding layer and the second grounding layer is formed in the calibration board; and

S2: stacking the feeding board, the reinforcement board and the calibration board and fixing the feeding board, the reinforcement board and the calibration board in a riveting manner.

In addition, a clearance area is formed in the second grounding layer; and a signal transfer board electrically connected with the signal line layer is arranged in the clearance area.

In addition, the manufacturing method of the antenna substrate further comprises the steps of: forming a penetrating avoidance hole in the feeding board, the reinforcement board and the calibration board, and arranging the conductive column in the avoidance hole in a penetrating manner for electrically connecting the feeding network and the signal transfer board.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is structural illustration of an array antenna provided by an embodiment of the invention.

FIG. 2 is a cross-sectional view of an antenna substrate provided by the embodiment of the invention.

FIG. 3 is a flow chart of a manufacturing method of the antenna substrate.

FIG. 4 is a structural view of a feeding board and a calibration board of a related antenna.

### DETAILED DESCRIPTION OF THE EXEMPLARY EMBODIMENT

The present disclosure will hereinafter be described in detail with reference to several exemplary embodiment. To make the technical problems to be solved, technical solutions and beneficial effects of the present disclosure more apparent, the present disclosure is described in further detail together with the figure and the embodiment. It should be understood the specific embodiments described hereby is only to explain the disclosure, not intended to limit the disclosure.

It is to be noted that all directional indicators in the embodiments of the invention (for example, upper, lower, left, right, front, back, inner, outer, top, bottom and the like) are only used for explaining relative position relationships among parts in some special gesture (for example, shown in the drawings) and so on. If the special gesture changes, the directional indicators also change correspondingly.

It should also be noted that when an element is referred to as being “fixed” or “disposed” on another element, the element may be directly on the other element or there may be intervening elements at the same time. When an element is called “connected” to another element, it may be directly connected to the other element or there may be intervening elements at the same time.

Referring to FIG. 1, a base station antenna 300, provided by the embodiment of the invention, comprises an antenna substrate 100 and a plurality of antenna elements 200 arranged on the antenna substrate 100 in array distribution.

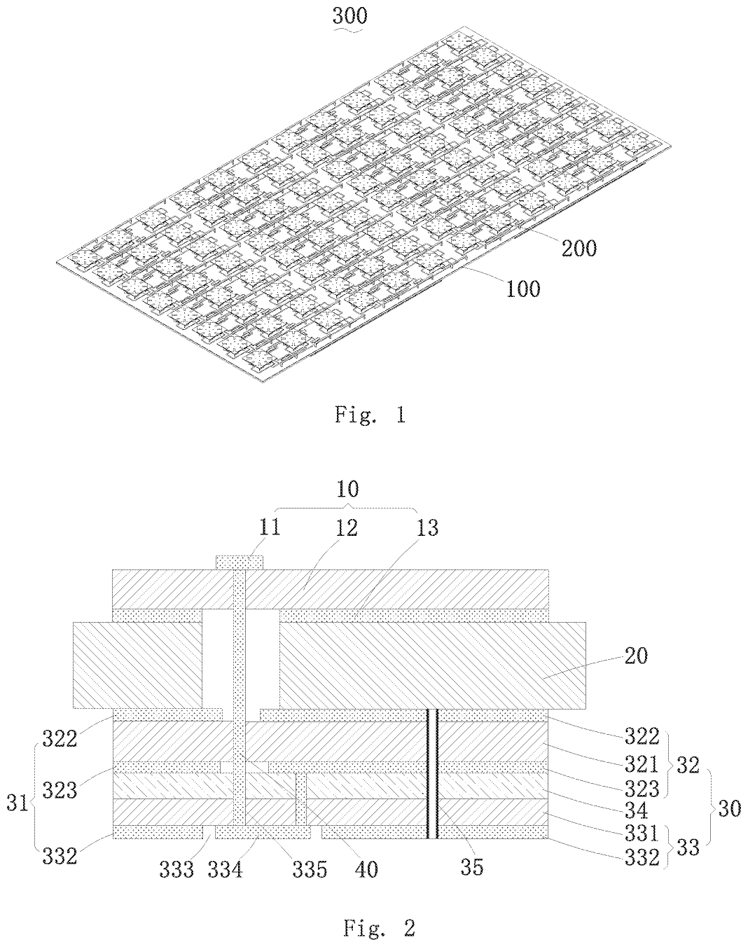

Referring to FIG. 2, the antenna substrate 100 comprises a feeding board 10, a reinforcement board 20 and a calibration board 30. The feeding board 10 and the calibration board 30 are independently manufactured separately; and the feeding board 10, the reinforcement board 20 and the calibration board 30 are stacked and are fixed in a riveting manner to form the antenna substrate 100. The feeding board 10 comprises a feeding network 11 for feeding the antenna elements 200; the calibration board 30 comprises a calibration network 31; and the calibration network 31 is used for calibrating an amplitude and a phase of a signal transmitted to the feeding network.

When the array antenna 300 is used, the signal transmitted to the antenna elements 200 is firstly calibrated by the calibration network 31 and then enters the feeding network 11 to be transmitted to the antenna elements 200, and the detection precision of the calibration network 31 can directly affect beam forming and the calculation accuracy of a signal arrival azimuth. Specifically, the feeding network 11 is of a microstrip line structure, the calibration network 31 is of a strip line structure, and the calibration network 31 is composed of a directional coupler and a combiner.

In the embodiment, through independent and separate manufacturing of the feeding board 10 and the calibration board 30 compared with an existing method of manufacturing the feeding board and the calibration board into a whole PCB board, the antenna substrate has the advantages that a back drilling process is not required in the manufacturing process of the antenna substrate 100, processing is simple and the cost is low. Moreover, the feeding board 10 and the calibration board 30 are independently manufactured separately, so that the calibration board 30 and the feeding board 10 can be manufactured into different sizes, specifically, the size of the calibration board 30 can be reduced, thereby reducing the material cost and reducing the space occupation.

The reinforcement board 20 is used for enhancing the strength of the antenna substrate 100, and is preferably a metal board, more preferably an aluminum board. It will be understood that, in some embodiments, the reinforcement board 20 cannot be added to the antenna substrate 100, that is, the antenna substrate 100 can be fixed by the feeding board 10 and the calibration board 30 through assembly. Furthermore, the feeding board 10, the reinforcement board 20 and the calibration board 30 can be fixedly connected in, but not limited to, a riveting manner, for example, the feeding board 10, the reinforcement board 20 and the calibration board 30 can also be tightly connected in a bolt connection manner.

As an improvement of the embodiment, the calibration board 30 comprises a first circuit board 32, a second circuit board 33 arranged at one side, far away from the reinforcement board 20, of the first circuit board 32, and a bonding layer 34 arranged between the first circuit board 32 and the second circuit board 33; and the first circuit board 32 and the second circuit board 33 are bonded and fixed through the bonding layer 34.

Specifically, the first circuit board 32 comprises a first medium board 321, and a first grounding layer 322 and a signal line layer 323 arranged on two opposite surfaces of the first medium board 321. The second circuit board 33 comprises a second medium board 331 and a second grounding layer 332 arranged on the surface, far away from the first circuit board 32, of the second medium board 331. The first grounding layer 332, the first medium board 321, the signal line layer 323, the bonding layer 34, the second medium board 331 and the second grounding layer 332 are sequentially stacked in the direction far away from the reinforcement board 20 from one side, far away from the feeding board 10, of the reinforcement board 20. The signal line layer 323 is electrically connected with the second grounding layer 332; and the first grounding layer 322, the signal line layer 323 and the second grounding layer 332 form the calibration network 31.

As an improvement of the embodiment, a metallized through hole 35 penetrating through the first medium board 321, the bonding layer 34 and the second medium board 331 is formed in the calibration board 30. The first grounding layer 322 communicates with the second grounding layer 332 through the metallized through hole 35.

As an improvement of the embodiment, the antenna substrate 100 further comprises a conductive column 40; a clearance area 333 is formed in the second grounding layer 332; a signal transfer board 334 is arranged in the clearance area 333; an avoidance hole 335 is formed in the feeding board 10, the reinforcement board 20, the first circuit board 32, the bonding layer 33 and the second circuit board 33 in a penetrating manner; the conductive column 40 is arranged in the avoidance hole 335 in a penetrating manner to electrically connect the feeding network 11 and the signal transfer board 334; and the signal line layer 323 is electrically connected with the signal transfer board 323. Specifically, the signal line layer 323 and the signal transfer board 323 can be electrically connected through a metal probe. Therefore, the feeding network 11 is electrically connected with the calibration network 31 through the signal transfer board 323.

As an improvement of the embodiment, the feeding board 10 further comprises a third medium board 12 and a third grounding layer 13. The feeding network 11 is arranged at one side, far away from the reinforcement board 20, of the third medium board 12. The third grounding layer 13 is arranged between the third medium board 12 and the reinforcement board 20.

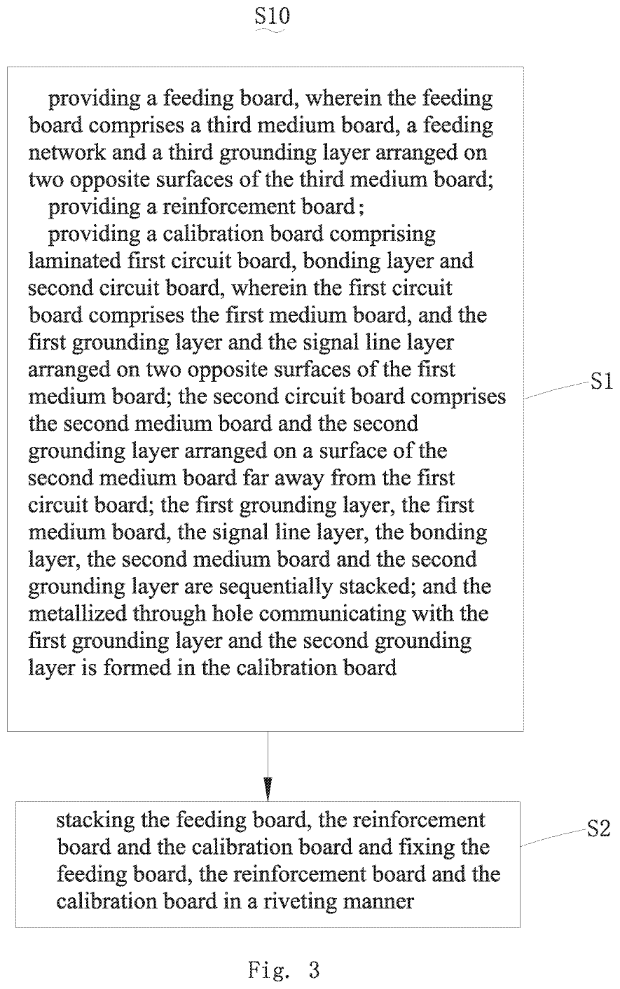

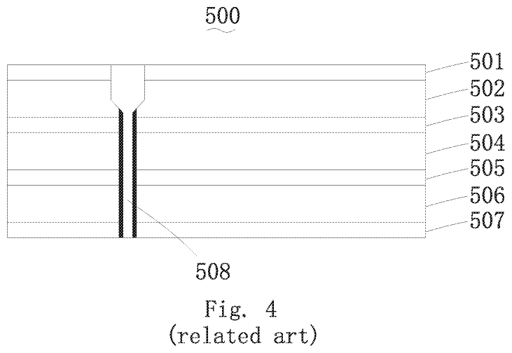

Referring to FIGS. 1 to 3, a manufacturing method S10 of the antenna substrate, provided by the embodiment of the invention, comprises the following steps of:

S1: providing the feeding board 10, wherein the feeding board 10 comprises the third medium board 12, and the feeding network 11 and the third grounding layer 13 arranged on two opposite surfaces of the third medium board 12;

providing the reinforcement board 20;

providing the calibration board 30, wherein the calibration board 30 comprises laminated first circuit board 32, bonding layer 34 and second circuit board 33; the first circuit board 32 comprises the first medium board 321, and the first grounding layer 322 and the signal line layer 323 arranged on two opposite surfaces of the first medium board 321; the second circuit board 33 comprises the second medium board 331 and the second grounding layer 332 arranged on the surface, far away from the first circuit board 32, of the second medium board 331; the first grounding layer 332, the first medium board 321, the signal line layer 323, the bonding layer 34, the second medium board 331 and the second grounding layer 332 are sequentially stacked; and the metallized through hole 35 communicating with the first grounding layer 322 and the second grounding layer 332 is formed in the calibration board 30; and

S2: stacking and fixing the feeding board 10, the reinforcement board 20 and the calibration board 30 in a riveting manner.

As an improvement of the embodiment, the clearance area 333 is formed in the second grounding layer 332. The signal transfer board 334 electrically connected with the signal line layer 323 is arranged in the clearance area 333.

As an improvement of the embodiment, the manufacturing method S10 of the antenna substrate further comprises the following steps of:

forming the penetrating avoidance hole 335 in the feeding board 10, the reinforcement board 20 and the calibration board 30 and arranging the conductive column 40 in the avoidance hole 335 in a penetrating manner to electrically connect the feeding network 11 and the signal transfer board 334.

The feeding board 10 and the calibration board 30 are separately processed and formed, so that, compared with an existing method of manufacturing the feeding board 10 and the calibration board 30 into the whole PCB board, the manufacturing method of the antenna substrate provided by the embodiment has the advantages that the back drilling process is not required in the manufacturing process of the antenna substrate 100, processing is simple and the cost is low. Moreover, the feeding board 10 and the calibration board 30 are independently manufactured separately, so that the calibration board 30 and the feeding board 10 can be manufactured into different sizes, specifically, the size of the calibration board 30 can be reduced, thereby reducing the material cost and reducing the space occupation.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An antenna substrate, comprising:
a feeding board comprising a feeding network for feeding a plurality of antenna elements; and
a calibration board comprising a calibration network for calibrating an amplitude and a phase of a signal transmitted to the feeding network; wherein
the calibration network is electrically connected with the feeding network; and the calibration board and the feeding board are independently manufactured separately and fixed through assembly.

2. The antenna substrate as described in claim 1, further comprising a reinforcement board arranged between the feeding board and the calibration board, wherein the feeding board, the reinforcement board and the calibration board are fixed in a riveting manner.

3. The antenna substrate as described in claim 2, wherein the calibration board comprises a first circuit board, a second circuit board arranged at one side of the first circuit board far away from the reinforcement board, and a bonding layer arranged between the first circuit board and the second circuit board; the first circuit board and the second circuit board are bonded and fixed through the bonding layer.

4. The antenna substrate as described in claim 3, wherein the first circuit board comprises a first medium board, a first grounding layer and a signal line layer arranged on two opposite surfaces of the first medium board; the second circuit board comprises a second medium board and a second grounding layer arranged on a surface of the second medium board far away from the first circuit board; and the first grounding layer, the first medium board, the signal line layer, the bonding layer, the second medium board and the second grounding layer are sequentially stacked in a direction far away from the reinforcement board from one side of the reinforcement board far away from the feeding board.

5. The antenna substrate as described in claim 4, wherein a metallized through hole penetrating through the first medium board, the bonding layer and the second medium board is formed in the calibration board; and the first grounding layer communicates with the second grounding layer through the metallized through hole.

6. The antenna substrate as described in claim 4, further comprising a conductive column, wherein a clearance area is formed in the second grounding layer; a signal transfer board is arranged in the clearance area; an avoidance hole is formed in the feeding board, the reinforcement board, the first circuit board, the bonding layer and the second circuit board in a penetrating manner; the conductive column is arranged in the avoidance hole in a penetrating manner for electrically connecting the feeding network and the signal transfer board; and the signal line layer is electrically connected with the signal transfer board through a metal probe.

7. The antenna substrate of claim 1, wherein the feeding board comprises a third medium board, and the feeding network and a third grounding layer arranged on two opposite surfaces of the third medium board.

8. A manufacturing method of an antenna substrate, comprising the following steps of
S1: providing a feeding board, wherein the feeding board comprises a third medium board, a feeding network and a third grounding layer arranged on two opposite surfaces of the third medium board;
providing a reinforcement board;
providing a calibration board comprising laminated first circuit board, bonding layer and second circuit board, wherein the first circuit board comprises the first medium board, and the first grounding layer and the signal line layer arranged on two opposite surfaces of the first medium board; the second circuit board comprises the second medium board and the second grounding layer arranged on a surface of the second medium board far away from the first circuit board; the first grounding layer, the first medium board, the signal line layer, the bonding layer, the second medium board and the second grounding layer are sequentially stacked; and the metallized through hole communicating with the first grounding layer and the second grounding layer is formed in the calibration board; and
S2: stacking the feeding board, the reinforcement board and the calibration board and fixing the feeding board, the reinforcement board and the calibration board in a riveting manner.

9. The manufacturing method of the antenna substrate as described in claim 8, wherein a clearance area is formed in the second grounding layer; and a signal transfer board electrically connected with the signal line layer is arranged in the clearance area.

10. The manufacturing method of the antenna substrate as described in claim 9, further comprising the steps of:
forming a penetrating avoidance hole in the feeding board, the reinforcement board and the calibration board, and arranging the conductive column in the avoidance hole in a penetrating manner for electrically connecting the feeding network and the signal transfer board.
